(19) United States
(12) Patent Application Publication
(10) Pub. No.: US 2024/0392898 A1
(43) Pub. Date: Nov. 28, 2024

(54) CURVED DUCT AND METHOD OF MANUFACTURING SAME

(71) Applicant: Fran Lanciaux, Grand Rapids, OH (US)

(72) Inventor: Fran Lanciaux, Grand Rapids, OH (US)

(21) Appl. No.: 18/690,360

(22) PCT Filed: Oct. 7, 2021
(86) PCT No.: PCT/US2021/053893

§ 371 Date: Mar. 8, 2024

Related U.S. Application Data
(60) Provisional application No. 63/241,773, filed on Sep. 8, 2021.

(51) Int. Cl. F16L 9/17; B29C 53/06; B29L 23/00; F16L 59/14

(52) U.S. Cl. CPC F16L 9/17; B29C 53/06; F16L 59/143; B29L 2023/225

(57) ABSTRACT

A duct pre-form configured for forming a section of curved duct is provided. The duct pre-form includes a layer of foam insulative material. The layer of foam insulative material has a first and second major side. A first facing layer is attached to the first major side of the foam insulative material. A second facing layer is attached to the second major side of the foam insulative material. A plurality of depressions is formed in one of the major sides of the layer of foam insulative material and one of the first or second facing layers. The plurality of depressions is formed without breaking, tearing, ripping or otherwise marring the continuity of the first or second facing layers.

### RELATED APPLICATIONS

This application claims the benefit of pending PCT Patent Application No. PCT/US21/53893, filed Oct. 7, 2021 and U.S. Provisional Patent Application No. 63/241,773, filed Sep. 8, 2021, the disclosures of which are incorporated herein by reference in their entireties.

### BACKGROUND

Commercial and residential buildings have thermal distribution systems, many of which are air-based that distribute air through ductworks. It is desirable to insulate the distribution ductwork systems to limit leakage and conduction-loss problems. The extent of the duct-related thermal losses in uninsulated thermal distribution ductwork systems can depend on the location of the ductwork. In certain instances, large thermal losses can occur when significant portions of the uninsulated ductworks are located outside the building envelope.

Conventional insulation for thermal distribution systems can involve the installation of foam-based panels. In certain instances, the foam-based panels of conventional insulation can include the application of one or more layers of protective materials to the major face of the foam material. Following the application of the protective materials, the foam-based panels can be shaped as needed for a particular installation. In the scenario where the thermal distribution system involves ductwork having a circular cross-sectional shape, it is known to cut V-shaped or U-shaped channels in a foam-based panel and subsequently bend the cut panel into a circular or ovular shape.

It would be advantageous if the manufacturing processes for producing insulation for circular ductworks could be improved.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the curved duct and method of manufacturing same.

The above objects as well as other objects not specifically enumerated are achieved by a duct pre-form configured for forming a section of curved duct. The duct pre-form includes a layer of foam insulative material. The layer of foam insulative material has a first and second major side. A first facing layer is attached to the first major side of the foam insulative material. A second facing layer is attached to the second major side of the foam insulative material. A plurality of depressions is formed in one of the major sides of the layer of foam insulative material and one of the first or second facing layers. The plurality of depressions is formed without breaking, tearing, ripping or otherwise marring the continuity of the first or second facing layers.

The above objects as well as other objects not specifically enumerated are achieved by a method of manufacturing a duct pre-form, the duct pre-form configured for forming a section of curved duct. The includes the steps of seating a duct board on a forming table in a flat orientation, the duct board having a first facing layer attached to a first major side of a layer of foam insulative material and a second facing layer attached to a second major side of the foam insulative material, advancing the duct board along the forming table in a direction toward a forming die, positioning a first section of the duct board under the forming die, advancing the forming die in a direction toward the duct board, compressing the duct board with the forming die in a manner such as to form a first depression in the layer of foam insulation material and either the first or second facing layer without breaking, tearing, ripping or otherwise marring the continuity of the first or second facing layers and advancing the duct board a desired distance to form a subsequent depression in a similar manner.

The above objects as well as other objects not specifically enumerated are achieved by a forming fixture configured for manufacturing a duct pre-form, the duct pre-form configured for forming a section of curved duct. The forming fixture includes a forming table and a die press positioned at one end of the forming table. A fence is seated on the forming table and is configured for contact with a duct board. An advancement assembly is configured to advance the duct board seated on the forming table in a direction toward the die press. A control system is configured to actuate and control movement of the advancement assembly and movement of the die press. The control system is configured to control a range of spacing of depressions formed in the duct board, a depth of each of the depressions and an angle of bend of the duct board based on the density of a layer of foam insulation material within the duct board as well as elastomeric properties of the layer of foam insulation material.

Various objects and advantages of the curved duct and method of manufacturing same will become apparent to those skilled in the art from the following Detailed Description, when read in light of the accompanying drawings.

### BRIEF DESCRIPTION OF THE DRAWINGS

FIG. 1 is a perspective view of a duct board in accordance with the invention.

FIG. 2 is a cross-sectional view of a portion of the duct board of FIG. 1.

FIG. 3 is a cross-sectional view of a portion of a duct pre-form formed from the duct board of FIG. 1.

FIG. 4 is a schematic illustration of a portion of a forming fixture for forming the duct pre-form of FIG. 3.

FIG. 5 is a perspective view of a portion of the forming fixture of FIG. 4 showing a forming table.

FIG. 6 is a perspective view of a portion of the forming fixture of FIG. 4 showing a duct board seated on the forming table of FIG. 5.

FIG. 7 is a perspective view of a portion of the forming fixture of FIG. 4 showing an articulating arm.

FIG. 8 is a perspective view of a portion of an advancement assembly of the forming fixture of FIG. 4.

FIG. 9 is a perspective view of a portion of the forming fixture of FIG. 4 shown engaging the duct board of FIG. 1.

FIG. 10 is a perspective view of a forming die of the forming fixture of FIG. 4.

FIG. 11 is a perspective view of the forming fixture of FIG. 4 shown engaging the duct board of FIG. 1.

FIG. 12 is a perspective view of the forming fixture of FIG. 4 shown engaging the duct board of FIG. 1.

FIG. 13 is a perspective view of a duct pre-form as formed by the forming fixture of FIG. 4 shown being formed into a round duct.

FIG. 14 is an end view of a duct pre-form of FIG. 3 shown formed into an ovular duct.

### DETAILED DESCRIPTION

The curved duct and method of manufacturing the curved duct will now be described with occasional reference to specific embodiments. The curved duct and method of manufacturing the curved duct may, however, be embodied in different forms and should not be construed as limited to the embodiments set forth herein. Rather, these embodiments are provided so that this disclosure will be thorough and complete, and will fully convey the scope of the curved duct and method of manufacturing the curved duct to those skilled in the art.

Unless otherwise defined, all technical and scientific terms used herein have the same meaning as commonly understood by one of ordinary skill in the art to which the curved duct and method of manufacturing the curved duct belongs. The terminology used in the description of the curved duct and method of manufacturing the curved duct herein is for describing particular embodiments only and is not intended to be limiting of the curved duct and method of manufacturing the curved duct. As used in the description of the curved duct and method of manufacturing the curved duct and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the curved duct and method of manufacturing the curved duct. Notwithstanding that the numerical ranges and parameters setting forth the broad scope of the curved duct and method of manufacturing the curved duct are approximations, the numerical values set forth in the specific examples are reported as precisely as possible. Any numerical values, however, inherently contain certain errors necessarily resulting from error found in their respective measurements.

The description and figures disclose a curved duct configured for use as insulating bodies for thermal distribution systems and a novel method of manufacturing the curved duct. Generally, the curved duct involves the use of spaced-apart, stamped depressions formed in one major face of a flat panel and subsequent bending of the flat panel about spaced-apart, stamped depressions to form round, flat oval, rounded edge, rectangular or trapezoidal shapes. The flat panels are formed from a layer of foam insulation and opposing first and second facing layers. The spaced-apart, stamped depressions are formed without breaking, tearing, ripping or otherwise marring the continuity of the first and second facing layers.

The description and figures also disclose a forming fixture configured for manufacturing a duct pre-form, the duct pre-form configured for forming a section of curved duct. The forming fixture is configured to control a range of spacing of a plurality of depressions formed in the duct board, a depth of each of the depressions and an angle of bend of the duct board based on the density of a layer of foam insulation material within the duct board as well as elastomeric properties of the layer of foam insulation material.

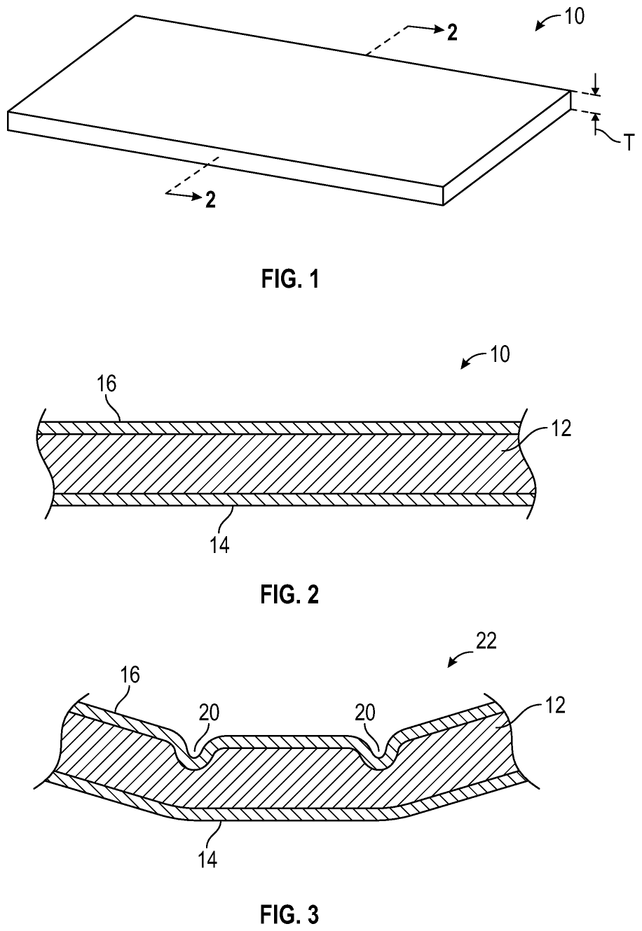

Referring now to the drawings, there is illustrated in FIGS. 1 and 2, a duct board 10 configured for formation into a curved section, referred to as a curved duct pre-form. The duct board 10 is a laminated assembly comprising more than one material. The duct board 10 includes a layer of foam insulation 12 and opposing first and second facing layers 14, 16.

Referring again to FIGS. 1 and 2, the layer of foam insulation 12 is configured as an insulative structure and has the form of a rigid phenolic material. The rigid phenolic material has a closed cell structure, a zero Ozone Depletion Potential (ODP), a high R-value, and excellent fire and heat resistance properties. It should be appreciated that in other embodiments, the layer of foam insulation 12 can have other forms and can be formed from other materials, suitable for the functions described herein.

Referring again to FIGS. 1 and 2, each of the opposing first and second facing layers 14, 16 are configured as a protective layer for the layer of foam insulation 12 and have the structure of a 1 mil low vapor permeability aluminum foil facing reinforced with a glass scrim. However, it should be appreciated that in other embodiments, each of the facing layers 14, 16 can have other forms and structures suitable to provide a protective layer for the layer of foam insulation 12. Each of the first and second facing layers 14, 16 can have any one of a range of thicknesses. As one non-limiting example, a thickness range of 0.3 mm to 2.0 mm is suitable. As another non-limiting example, a thickness of 1.0 mm is suitable.

Referring again to FIGS. 1 and 2, each of the opposing first and second facing layers 14, 16 are bonded to the layer of foam insulation 12 in a manner such as to provide permanent adhesion to the layer of foam insulation 12, one non-limiting example of a bonding method includes autobonding. However, other bonding methods, suitable for providing permanent adhesion of the facing layers 14, 16 to the layer of foam insulation 12 can be used.

Referring again to the embodiment shown in FIGS. 1 and 2, one non-limiting example of the duct board 10 is KoolDuct, manufactured and marketed by Kingspan Insulation LLC, headquartered in Atlanta, Georgia. The KoolDuct forming the duct board 10 has a thickness T of about ⅞″, 1 3/16″ and 1 5/16″. However, it should be appreciated that other duct boards 10 having other thicknesses, suitable for the functions described herein, can be used.

Referring again to FIGS. 1 and 2, optionally a polymer sheet (not shown for purposes of clarity) can be applied to the outer surface of the first facing layer 14. The polymer sheet can be formed from a thermoplastic material and good results have been obtained using PVC thermoplastic sheet material. In a finished duct, the polymer sheet will be on the outside and so the material should be selected for this type of service. In certain instances, the polymer sheet can contain additives to prolong its service life. As one non-limiting example, lithium oxide may be added to improve resistance to degradation caused by ultraviolet radiation. The polymer sheet is securely bonded to the first facing layer 14. Excellent results have been obtained with polyurethane adhesive systems. In any case, a strong and secure bond is required between the first facing layer 14 and the polymer sheet.

While the duct board 10 has been shown in FIGS. 1 and 2 and described above as having a layer of foam insulation 12 bounded by opposing first and second layers 14, 16 and optionally adhered to a polymer sheet, it is contemplated that in other embodiments, other suitable materials, densities, thicknesses, facings and/or laminates can be used. Non-limiting examples of suitable materials include metallic materials, metallic alloy-based materials, carbon-fiber materials and the like.

Referring now to FIG. 3, a plurality of spaced-apart, parallel depressions, indicated at 20, have been formed in the duct board 10, thereby forming a duct pre-form 22. The duct pre-form 22 has an arcuate cross-sectional shape. As will be explained in more detail below, duct having a circular or ovular cross-sectional shape is easily formed from the duct pre-form 22 by manipulating the duct pre-form 22 into a circular or ovular cross-sectional shape and fastening a resulting seam. As will also be described in more detail below, the spacing of adjacent depressions 20 and the depth of the depressions 20 are variable as a function of the curvature of the final duct.

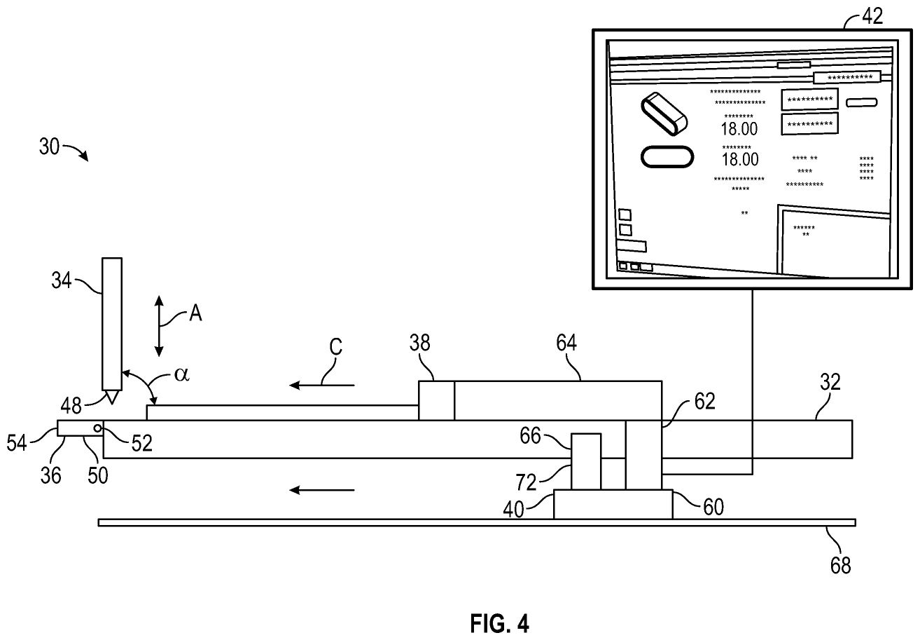

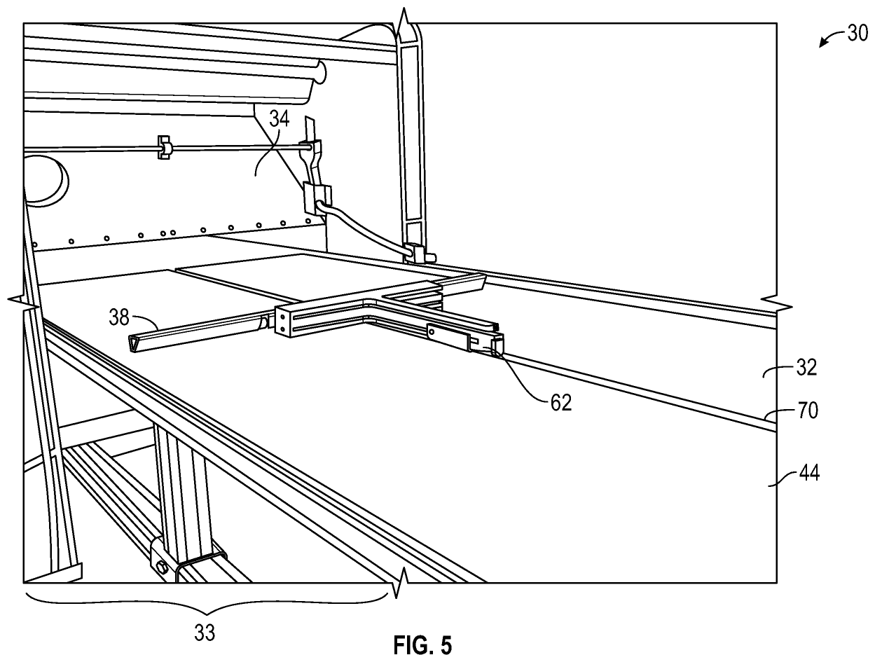

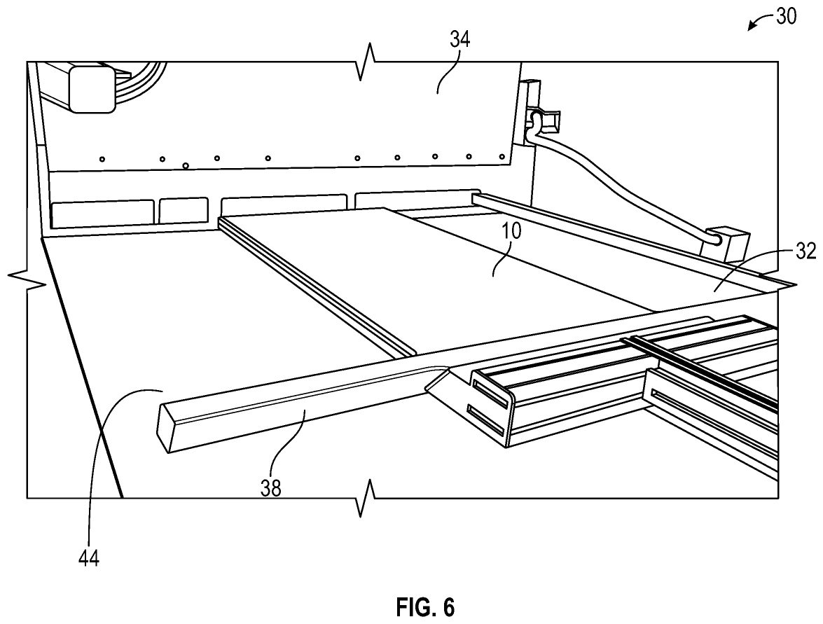

Referring now to FIG. 4, a forming fixture is illustrated generally at 30. The forming fixture 30 is configured for several functions. First, the forming fixture 30 is configured to impart the spaced-apart, parallel depressions 20 into the duct board 10. As the forming fixture 30 is forming the spaced-apart, parallel depressions 20, the forming fixture 30 is further configured to form the arcuate cross-sectional shape of the duct pre-form.

Referring again to FIG. 4, the forming fixture 30 includes a forming table 32, a die press 34, an articulating arm 36, a fence 38, an advancement assembly 40 and a control system 42.

Referring now to FIGS. 4-6, the forming table 32 is positioned on a supporting framework 33 and has a substantially flat upper surface 44 configured to receive the duct board 10, arranged in a flat orientation. The flat upper surface 44 of the forming table 32 is configured to facilitate sliding of the duct board 10 as the duct board 10 is moved across the forming table 32.

Referring again to FIGS. 4-6, the die press 34 is positioned at one end of the forming table 32 and is arranged in a manner such that a forming die 48 extending in a direction toward the forming table 32 from the forming press 34 forms an angle α with the duct board 10. The angle α is configured to orient each of the plurality of depressions 20 in the duct board 10 to facilitate a desired shape of the duct pre-form 22. In the illustrated embodiment, the angle α is about 90°. However, in other embodiments, the angle α can be more or less than about 90°, sufficient to facilitate a desired shape of the duct pre-form 22.

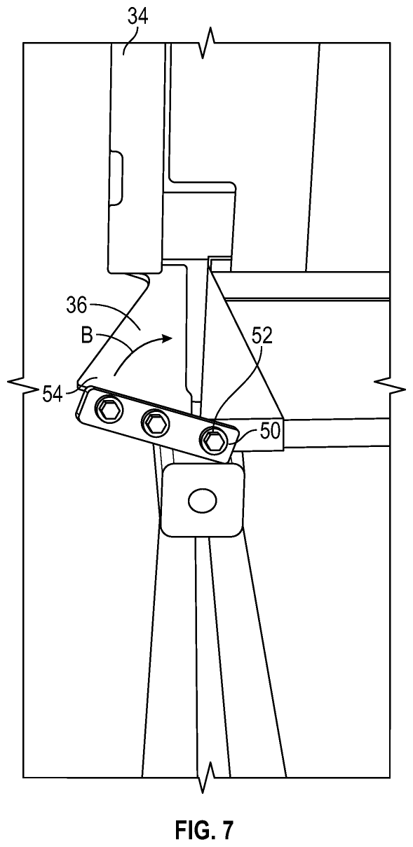

Referring now to FIGS. 4 and 7, the articulating arm 36 is positioned adjacent one end of the forming table 32 and outboard of the die press 34. An inboard end 50 of the articulating arm 36 is configured for rotation about a pivot point 52. In operation, as the forming die 48 travels in a vertically downward direction, as depicted by direction arrow A (FIG. 4), and engages the duct board 10, the articulating arm 36 pivots about the pivot point 52 in a manner such that an outboard end 54 of the articulating arm 36 moves in an upward arc, as depicted by direction arrow B (FIG. 7). The movement of the outboard end 54 of the articulating arm 36 in an upward arc is controlled in a manner sufficient to facilitate a desired arcuate cross-sectional shape of the duct pre-form 22.

Referring now to FIGS. 4-6, the fence 38 is configured for several functions. First, the fence 38 is configured to abut one side of the duct board 10 as the duct board 10 is seated on the forming table 32. Second, the fence 38 is connected to the advancement assembly 40 in a manner such that the fence 38 moves in a longitudinal direction along the forming table 32, with the movement controlled by the advancement assembly 40. Finally, the fence 38 is configured to move the duct board 10 in a direction toward the forming die 48, as depicted by direction arrow C (FIG. 4), in highly controlled increments of movement in a manner such as to form the spaced-apart depressions 20.

Referring again to the embodiment shown in FIGS. 4-6, the fence 38 has the cross-sectional shape of an inverted V. The inverted V cross-sectional shape is configured to engage the duct board 10 in a manner such as to maintain the engaged edge of the duct board 10 in contact with the forming table 32 and thereby maintaining the duct board 10 in the flat arrangement with the forming table 32. It should be appreciated that in other embodiments, the fence 38 can have other cross-sectional shapes, sufficient to maintain the engaged edge of the duct board 10 in contact with the forming table 32 and thereby maintaining the duct board 10 in the flat arrangement with the forming table 32.

Referring now to FIGS. 4, 5 and 8, the advancement assembly 40 is configured to advance the fence 38 along the upper surface 44 of the forming table 32 in highly controlled increments of movement in a manner such that the depressions 20 formed in the duct board 10 by the forming die 48 are spaced apart by desirable intervals. Referring first to FIG. 4, the advancement assembly 40 includes a carriage 60, an extension member 62, a thrust member 64 and a motive force 66.

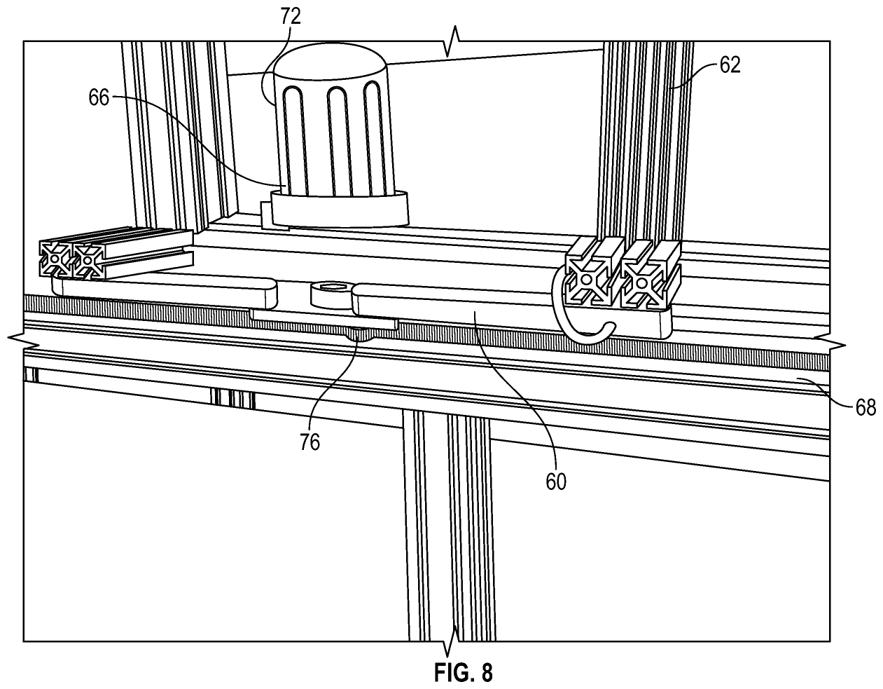

Referring now to FIGS. 4 and 8, the carriage 60 is movable along a track 68, with the track extending the length of the forming table 32. The carriage 60 is configured to support movement of the extension member 62, thrust member 64 and the motive force 66.

Referring now to FIGS. 4, 5 and 8, a first end of the extension member 62 is connected to the carriage 60 and a second end of the extension member is connected to the thrust member 64. The extension member extends in a generally upward direction through a longitudinal slot 70 formed in the forming table 32 (FIG. 5). The extension member 62 is configured to convey movement of the carriage 60 to the thrust member 64. In the illustrated embodiment, the extension member 62 has the form of a metallic, structural beam. However, in other embodiments, the extension member 62 can have other desired forms.

Referring now to FIGS. 4 and 8, a first end of the thrust member 64 is connected to the extension member 62 and a second end is connected to the fence 38. The thrust member 64 rides in the slot 70 in the forming table 32 and is configured to convey movement of the extension member 62 to the fence 38. In the illustrated embodiment, the thrust member 64 has the form of a metallic, structural beam. However, in other embodiments, the thrust member 64 can have other desired forms.

Referring again to FIGS. 4 and 8, the motive force 66 is configured to move the carriage 60, extension member 62, thrust member 64, fence 38 and the duct board 10 along the forming table 32 in highly controlled increments of movement in a manner such that the depressions 20 formed in the duct board 10 by the forming die 48 are spaced apart by desirable intervals. In the illustrated embodiment, the motive force 66 includes an electrically driven servo motor 72 and a circular drive gear (“pinion gear”) 76. The circular drive gear 76, driven for rotation by servo motor 72 is configured to engage the track 68, thereby producing the desired movement of the carriage 60, extension member 62, thrust member 64, fence 38 and duct board 10. It should be appreciated that in other embodiments, the carriage 60, extension member 62, thrust member 64, fence 38 and the duct board 10 can be moved along the forming table 32 in highly controlled increments of movements with other structures, systems and devices, sufficient to form the depressions 20 in the duct board 10 with desired intervals. Examples of suitable non-limiting systems include pneumatic systems and hydraulic systems.

Referring now to FIG. 4, movement of the motive force 66 is controlled by the control system 42. In the illustrated embodiment, the control system 42 has the form of a programmable logic controller (“PLC”), thereby allowing entry of control inputs such as the range of spacing of the depressions, the angle of bend formed by the articulating arm 36, the quantity of depressions 20, the depth of the depressions 20, the thickness of the duct board 10 and the like. It is contemplated that in other embodiments, the movement of the motive force 66 can be controlled with other structures, systems and devices, sufficient for the functions described herein.

Referring again to FIG. 4, the range of spacing (or interval), the depth of the depressions and the angle of bend are a function of the density of the layer of foam insulation 12 as well as the elastomeric properties (spring-back) of the layer of foam insulation 12. It should also be appreciated that the range of spacing (interval) can vary based on the desired end shape of the duct, such as the non-limiting examples of a circle or a flat oval.

Referring again to FIG. 4, the angle of bend of the duct board 10 is the angle required when concurrently making a compression in the duct board 10 by the forming die 48 as determined by the quantity of depressions based on calculations made by the range of spacing. The angle of bend may change based on the elastomeric properties of the layer of foam insulation 12. In certain instances, over-bending may be necessary to achieve the final shape desired. In certain instances, the angle of bend can be in a range of from about 1.0 degrees to 60.0 degrees.

Referring again to FIG. 4, the quantity of depressions 20 is the number of depressions required to form the desired duct shape as calculated by the range of spacing. Increasing the quantity of depressions 20 reduces the depth of the depressions, but may also cause damage to the duct pre-form 22 being formed. Getting the correct quantity of depressions 20 determines the life of the circular shaped foam panel. The quantity of depressions 20 can range from 6 per panel up to 2000 per panel depending on the diameter of the duct pre-form 22 being made, the density of layer of foam insulation 12 being formed as determined by the range of spacing and the thickness of the duct board 10.

Referring again to FIG. 4, the depth of the depressions 20 is a function of the range of spacing determination. The depth of the depressions 20 increase as the angle of bend increases due to the offset required to take up the change in the inner and outer radius as a result of forming a duct pre-form 22. In the event the duct pre-form 22 being formed has facings, the inside radius (stretch-out) is less than the outside radius (stretch-out) which varies by the thickness of the duct board 10. These changes in stretch-out radius are influenced by material thickness, resulting in a need for offsets or reduction in distance from the quantity of depressions. This is necessary as to prevent delamination of the facings 14, 16 on either the compressed or opposing side of the duct board 10. As one non-limiting example, the depth of the depressions 20 can range from about 0.25 inches to about 6.0 inches depending on the range of spacing calculations. A 6.0 inch internal diameter circular round shape formed by compressing a 22 mm (⅞″) phenolic foam panel has an outside diameter stretch-out circumference length of approximately 24.35″ while the inside diameter stretch-out circumference length is only 18.85″, which means the depth of the depressions is the difference of 24.35″ minus 18.85″ divided by the quantity of depressions. If the quantity of depressions is 15, the resulting depth of the depression would need to be 0.3667″ in depth at each depression in order to reduce the internal radius to the proper distance without delaminating the facings 14, 16 from the layer of foam insulation 12.

Summarizing, and without being held to the theory, the range of spacing of the depressions 20 and the angle of bend will vary with the quantity of depressions 20, and will then influence the depth of the depressions 20. Since each type and density of the layer of foam insulation 12 can be different, the range of spacing, angle of bend, quantity of depressions 20 and the depth of the depressions 20 can vary with the change in product due to the nature of the product's elasticity or tolerance to formation from compression.

Referring now to FIGS. 4-7 the method of forming the duct pre-forms 22 and the method of forming the duct pre-form 22 into a circular or ovular cross-sectional shapes will now be described. Referring first to FIG. 4 in an initial step, required inputs, including but not limited to the range of spacing, angle of bend, quantity of depressions 20 and the depth of the depressions 20 are entered into the control system 42.

Referring now to FIGS. 5 and 6 in a next step, the advancement assembly 40 is configured such that a suitable clearance is established between the fence 38 and the die press 34. A suitable clearance is one that allows a duct board 10 to seat flat against the upper surface 44 of the forming table, which is completed in a next step.

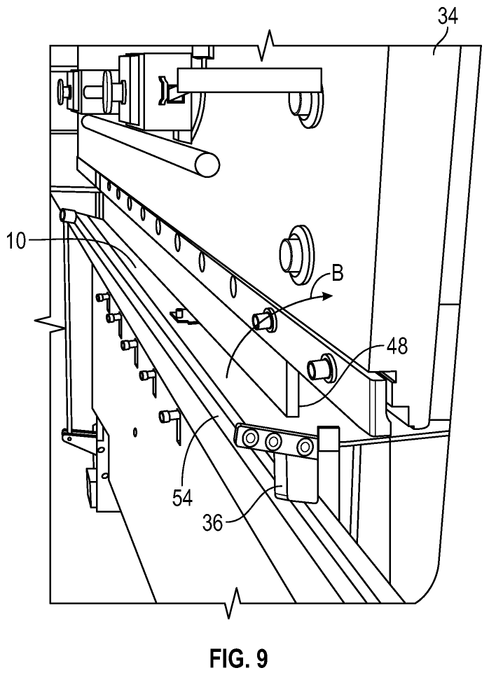

Referring now to FIG. 9 in a next step, the leading edge of the duct board 10 is advanced by the advancement assembly 40 to a position where an initial segment of the duct board 10 is positioned below the forming die 48. In a simultaneous manner, the forming die 48 is lowered into contact with the duct board 10 and the outboard end 54 of the articulating arm 36 moves in an upward arc, as depicted by direction arrow B. The forming die 48 forms a first depression 20 in the duct board 10 and the initial segment of the duct board 10 is urged in the upward arc indicated by direction arrow B.

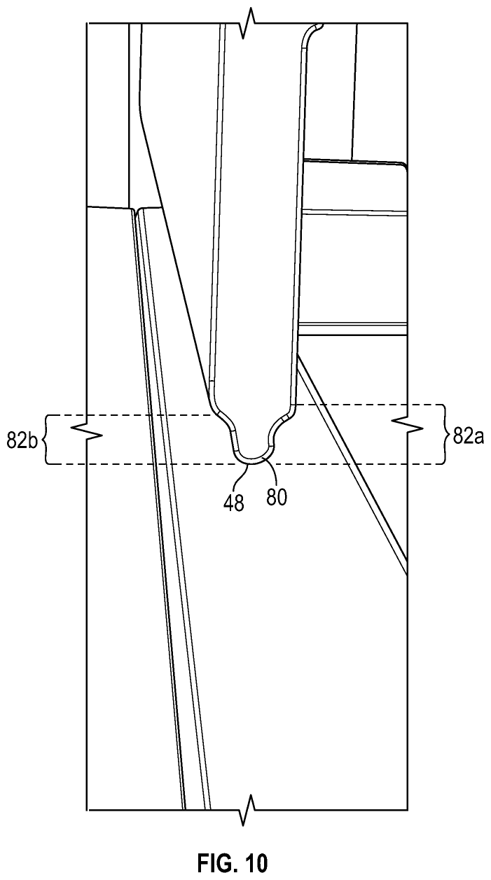

Referring now to FIG. 10, an end view of the forming die 48 is shown. The forming die 48 includes a rounded end projection 80 and opposing relief areas 82 positioned on either side of the rounded end projection 80. The rounded end projection 80 and opposing relief areas 82 are configured to form the plurality of depressions 20 (FIG. 3) in the duct board 10. As can be seen in FIG. 3, each of the depressions 20 has a depth that is less than the thickness of the duct board 10. As also can be seen in FIG. 3, the rounded end projection 80 and the opposing relief areas 82 are configured to form the depressions 20 without breaking, tearing, ripping or otherwise marring the continuity of the second facing layer 16. As also can be seen in FIG. 3, the rounded end projection 80 and the opposing relief areas 82 are also configured to form the depressions 20 without breaking, tearing, ripping or otherwise marring the continuity of the first facing layer 14.

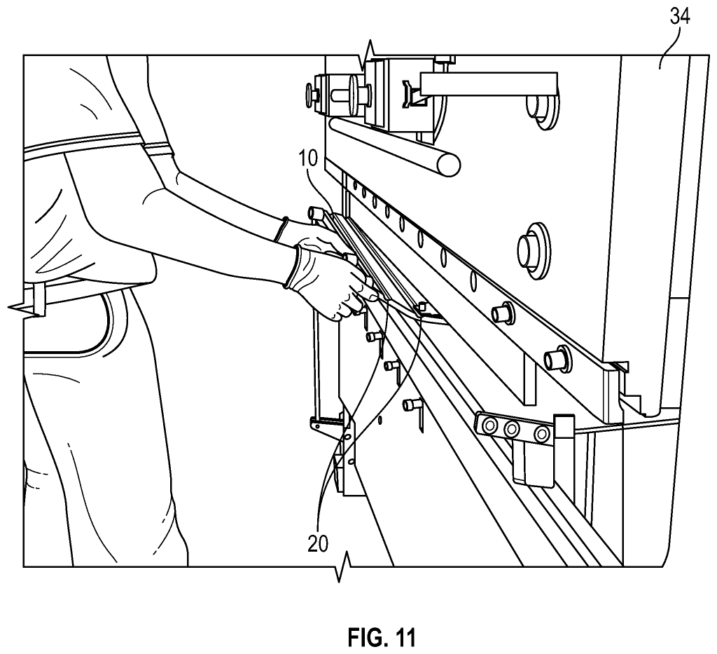

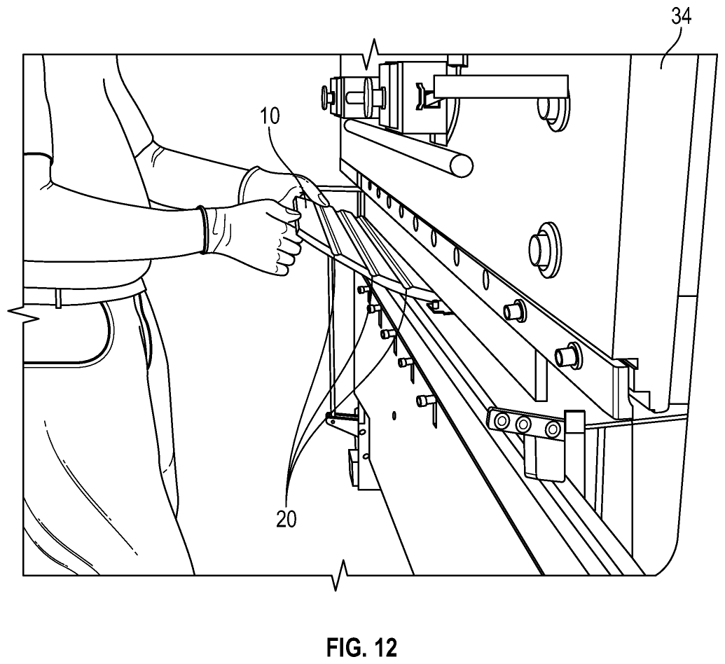

Referring now to FIGS. 11 and 12, advancement of the duct board 10 continues, as determined by the advancement assembly 40, and the spaced apart subsequent depressions 20 are formed in the duct board 10 at desired intervals, thereby forming the duct pre-form 22.

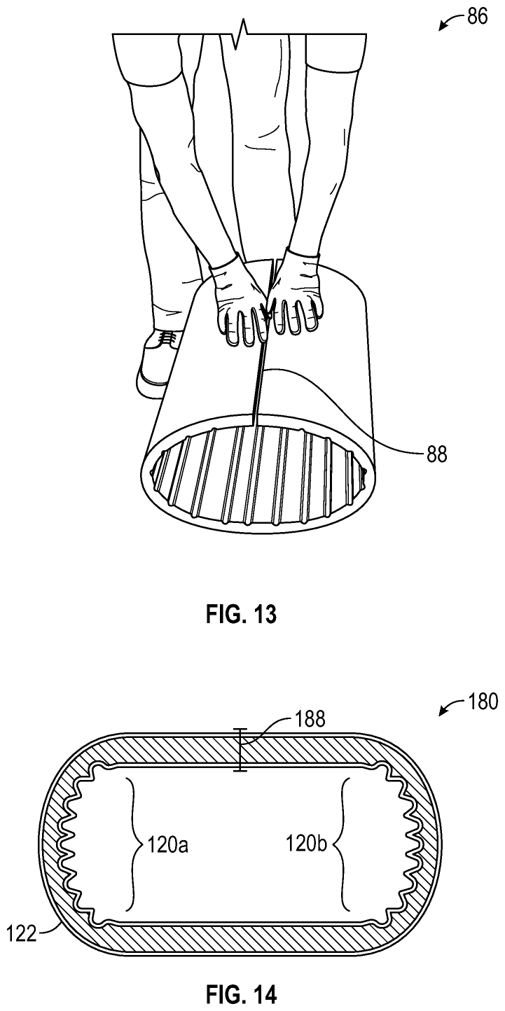

Referring now to FIG. 13 is a next step, the duct pre-form 22 is removed from the forming fixture 30. The duct pre-form 22 is easily assembled into a round duct 86. A seam 88 formed where the two edges of the duct pre-form 22 meet can be secured with any desired structure, including the non-limiting examples of tape, clips, bands and the like.

Referring now to FIG. 14 in another embodiment, a duct pre-form 122 having two sets of depressions 120a, 120b spaced apart from each other is easily assembled into an oval duct 180. A seam 188 formed where the two edges of the duct pre-form 22 meet can be secured with any desired structure, including the non-limiting examples of tape, clips, bands and the like.

In accordance with the provisions of the patent statutes, the principle and mode of operation of the curved duct and method of manufacturing the curved duct have been explained and illustrated in a certain embodiment. However, it must be understood that the curved duct and method of manufacturing the curved duct may be practiced otherwise than as specifically explained and illustrated without departing from its spirit or scope.

What is claimed is:

1. A duct pre-form configured for forming a section of curved duct, the duct pre-form comprising:
a layer of foam insulative material, the layer of foam insulative material having a first and second major side;
a first facing layer attached to the first major side of the foam insulative material;
a second facing layer attached to the second major side of the foam insulative material; and
a plurality of depressions formed in one of the major sides of the layer of foam insulative material and one of the first or second facing layers, the plurality of depressions formed without breaking, tearing, ripping or otherwise marring the continuity of the first or second facing layers.

2. The duct pre-form of claim 1, wherein the layer of foam insulative material is rigid phenolic material.

3. The duct pre-form of claim 1, wherein the second facing layer has the structure of a 1 mil low vapor permeability aluminum foil facing reinforced with a glass scrim.

4. The duct pre-form of claim 1, wherein the plurality of depressions is arranged in a parallel orientation.

5. The duct pre-form of claim 1, wherein a quantity of the spaced apart depressions is a function of the density of the layer of foam insulative material and also a function of the elastomeric properties (spring-back) of the layer of foam insulative material.

6. The duct pre-form of claim 1, wherein a depth of the spaced apart depressions is a function of a range of spacing of the depressions and also a function of an angle of bend of the duct pre-form.

7. A method of manufacturing a duct pre-form, the duct pre-form configured for forming a section of curved duct, the method comprising the steps of:
seating a duct board on a forming table in a flat orientation, the duct board having a first facing layer attached to a first major side of a layer of foam insulative material and a second facing layer attached to a second major side of the foam insulative material;
advancing the duct board along the forming table in a direction toward a forming die;
positioning a first section of the duct board under the forming die;
advancing the forming die in a direction toward the duct board;
compressing the duct board with the forming die in a manner such as to form a first depression in the layer of foam insulation material and either the first or second facing layer without breaking, tearing, ripping or otherwise marring the continuity of the first or second facing layers; and
advancing the duct board a desired distance to form a subsequent depression in a similar manner.

8. The method of claim 7, wherein the layer of foam insulative material is rigid phenolic material.

9. The method of claim 7, wherein the second facing layer has the structure of a 1 mil low vapor permeability aluminum foil facing reinforced with a glass scrim.

10. The method of claim 7, including the step of forming the plurality of depressions in a parallel orientation.

11. The method of claim 7, including the step of spacing apart the depressions a distance based on the density of the layer of foam insulative material and also based on the elastomeric properties (spring-back) of the layer of foam insulative material.

12. The method of claim 7, including the step of forming a depth of the spaced apart depressions based on a range of spacing of the depressions and also based on an angle of bend of the duct pre-form.

13. The method of claim 7, including the step of varying a range of spacing, angle of bend, a quantity of the depressions and a depth of the depressions based on an elasticity or tolerance to formation from compression of the layer of insulative material.

14. A forming fixture configured for manufacturing a duct pre-form, the duct pre-form configured for forming a section of curved duct, the forming fixture comprising:
a forming table;
a die press positioned at one end of the forming table;
a fence seated on the forming table and configured for contact with a duct board;
an advancement assembly configured to advance the duct board seated on the forming table in a direction toward the die press; and
a control system configured to actuate and control movement of the advancement assembly and movement of the die press;
wherein the control system is configured to control a range of spacing of depressions formed in the duct board, a depth of each of the depressions and an angle of bend of the duct board based on the density of a layer of foam insulation material within the duct board as well as elastomeric properties of the layer of foam insulation material.

15. The forming fixture of claim 14, wherein the forming table includes a longitudinal slot configured to receive a portion of the advancement assembly.

16. The forming fixture of claim 14, wherein the die press includes a forming die having a rounded end projection and opposing relief areas abutting the rounded end projection.

17. The forming fixture of claim 14, wherein the die press includes an articulating arm configured to rotate a portion of the duct board as depressions are formed in the duct board.

18. The forming fixture of claim 14, wherein the fence has a cross-sectional shape of an inverted V.

19. The forming fixture of claim 14, wherein the advancement assembly includes an electrically driven servo motor configured to advance the fence in highly controlled increments of movement.

20. The forming fixture of claim 14, wherein the control system is configured to receive inputs for forming the duct pre-form, including a range of spacing of depressions formed in the duct board, a depth of each of the depressions, an angle of bend of the duct board, a density of a layer of foam insulative material within the duct board and elastomeric properties of the layer of foam insulative material.
